(19) United States
(12) Patent Application Publication
(10) Pub. No.: US 2026/0252934 A1
(43) Pub. Date: Aug. 27, 2026

(54) SYSTEMS AND METHODS FOR QUBIT INITIALISATION AND CONTROL

(71) Applicant: Silicon Quantum Computing Pty Limited, Kensington, NSW (AU)

(72) Inventors: Jonathan Reiner, Kfar Haroeh (IL); Michelle Yvonne Simmons, Sydney (AU); Samuel Keith Gorman, Sydney (AU); Md Serajum Monir, Sydney (AU); Ludwik Kranz, Sydney (AU); Christian Moehle, Sydney (AU); Keshavi Charde, Sydney (AU)

(21) Appl. No.: 18/992,541

(22) PCT Filed: Jul. 7, 2023
(86) PCT No.: PCT/AU2023/050629

§ 371 Date: Jan. 8, 2025

(30) Foreign Application Priority Data
Jul. 8, 2022 (AU) 2022901917
Mar. 6, 2023 (AU) 2023900597

(51) Int. Cl. G06N 10/40

(52) U.S. Cl. CPC G06N 10/40

(57) ABSTRACT

A method for initialising a predetermined target spin state of a multi-donor quantum dot in a semiconductor substrate, the method comprising: i) loading an electron onto the multi-donor quantum dot in a spin-down state; ii) performing zero or one electron reset pulses; iii) applying an RF signal to drive at least one EDSR transition; and iv) repeating steps ii)-iii) N times to achieve the predetermined target spin state.

### TECHNICAL FIELD

Aspects of the present disclosure are related to advanced processing systems and more particularly, to quantum processing systems and to methods and systems for initializing and/or controlling processing elements.

### BACKGROUND

The developments described in this section are known to the inventors. However, unless otherwise indicated, it should not be assumed that any of the developments described in this section qualify as prior art merely by virtue of their inclusion in this section, or that those developments are known to a person of ordinary skill in the art.

Large-scale quantum processing systems hold the promise of a technological revolution, with the prospect of solving problems, which are out of reach with classical machines. To date, a number of different structures, materials, and architectures have been proposed to implement quantum bits (or qubits) and corresponding quantum control and processing systems.

Before such large-scale quantum computers can be manufactured commercially, a number of hurdles need to be overcome. Precise measurement of qubit states at any given time in a quantum processing device is one such essential requirement. Different types of sensors and qubit measurement and initialization techniques have been proposed in the art. Some of these techniques may however be prone to errors. Accordingly, improved techniques for measuring qubit states and/or initializing qubits in quantum processing systems are desirable.

### SUMMARY

According to a first aspect of the invention, there is provided a method for initialising a predetermined target spin state of a multi-donor quantum dot in a semiconductor substrate, the method comprising: i) loading an electron onto the multi-donor quantum dot in a spin-down state; ii) performing zero or one electron reset pulses; iii) applying an RF signal to drive at least one EDSR transition; and iv) repeating steps ii)-iii) N times to achieve the predetermined target spin state.

According to a second aspect of the invention, there is provided a method for initialising a predetermined target spin state of a multi-donor quantum dot in a semiconductor substrate, the method comprising: i) determining an initialisation pulse sequence dependent on the predetermined target spin state, the initialisation pulse sequence comprising at least one electron reset pulse and at least one EDSR transition; ii) loading an electron onto the multi-donor quantum dot in a spin-down state; iii) applying the initialisation pulse sequence; and iv) repeating step iii) N times to achieve the predetermined target spin state.

According to a third aspect of the invention, there is provided a method for initialising a predetermined target spin state of a multi-donor quantum dot in a semiconductor substrate, the method comprising: i) loading an electron onto the multi-donor quantum dot in a spin-down state; ii) performing an ESR measurement to determine the total nuclear spin state; in accordance with a determination the total nuclear spin state of the multi-donor quantum dot is not the target spin state; iii) determining and executing an initialisation pulse sequence; wherein, the initialisation pulse sequence comprises at least one ESR spin reset pulse and at least one EDSR transition; performing an ESR measurement to determine the total nuclear spin state; in accordance with a determination the total nuclear spin state of the multi-donor quantum dot is the target spin state, initialising the nuclear spins; in accordance with a determination that the total nuclear spin state of the multi-donor quantum dot is not the target spin state returning to step iii).

According to a fourth aspect of the invention, there is provided a quantum processing element configured to initialise a predetermined target spin state in a multi-donor quantum dot, the quantum processing element comprising: a semiconductor substrate and a dielectric material forming an interface with the semiconductor substrate; a multi-donor quantum dot embedded in the semiconductor substrate, the multi-donor quantum dot comprising at least two donor atoms, the at least two donor atoms sharing at least one electron; and a control element for controlling the multi-donor quantum dot; wherein the electron is loaded onto the multi-donor quantum dot in a spin-down state; and wherein the control element is configured to: apply an RF signal to drive at least one EDSR transition; and apply at least one electron spin reset pulse; thereby to achieve the target spin state and initialise the quantum dot.

### BRIEF DESCRIPTION OF DRAWINGS

Features and advantages of the present invention will become apparent from the following description of embodiments thereof, by way of example only, with reference to the accompanying drawings, in which:

FIG. 1A shows a top view of an embodiment of a donor spin qubit device formed in a silicon substrate using a donor atom.

FIG. 1B shows a cross-sectional side view of the device of FIG. 1A.

FIG. 2A shows an embodiment of a multi-donor quantum dot device.

FIG. 2B shows a further embodiment of a multi-donor quantum dot device with an in-plane gate.

FIG. 2C shows another example of a multi-donor quantum dot device.

FIG. 3A shows the eight possible transitions between the spin states of a 2P quantum dot driven by electron spin resonance (ESR) or electron dipole spin resonance (EDSR).

FIG. 3B shows the frequencies of the ESR and EDSR spin up transitions of FIG. 3A for the 2P quantum dot.

FIG. 4A shows the twelve possible EDSR transitions for a 3P quantum dot.

FIG. 4B shows the frequencies of the EDSR spin up transitions of FIG. 4A for the 3P quantum dot.

FIG. 5A is a flowchart illustrating an example method for initialising a multi-donor qubit device using EDSR.

FIG. 5B is a flowchart illustrating an alternative example method for initialising a multi-donor qubit device using EDSR.

FIG. 6A shows an electron-spin up fraction as a function of the nuclear spin configurations for a first example 2P quantum dot system before an initialisation protocol has been performed.

FIG. 6B shows the electron-spin up fraction as a function of the nuclear spin configurations for a first example 3P quantum dot system before an initialisation protocol has been performed.

FIG. 7A shows an ESR measurement after the initialisation protocol has been performed on the first example 2P quantum dot system.

FIG. 7B shows the ESR measurement after the initialisation protocol has been performed on the first example 3P quantum dot system.

FIG. 7C shows three different initialisation pulse sequences leading to a similar outcome of initialisation of the first | [symbol] [symbol] peak for the example 3P device of FIG. 6B.

FIGS. 8A and 8B shows the Rabi-chevron experimental results for the first example 2P and 3P quantum dot systems, respectively.

FIG. 9A shows an EDSR energy diagram for the first example 3P quantum dot system.

FIG. 9B shows a plot of the measured EDSR spectrum corresponding to the 12 different transition frequencies of the first example 3P quantum dot system shown in FIG. 9A.

FIG. 9C shows the inversion probability for EDSR transitions corresponding to a flip of the first, second and third nuclear spin, respectively—when starting from initial state |↓ [symbol] [symbol] .

FIG. 9D is a plot showing the dependence of the Rabi frequency on the square-root microwave power.

FIG. 10A shows the measured ESR spectrum after applying an initialisation sequence to initialise the nuclear spin states to the target state | [symbol] [symbol] .

FIG. 10B shows the measured ESR spectrum after applying an initialisation sequence to initialise the nuclear spin states to the target state | [symbol] [symbol] .

FIG. 10C shows the initialisation fidelity starting from an initial state (i) and transitioning to the target state j=| [symbol] [symbol] .

FIG. 10D shows the initialisation fidelity starting from an initial state (i) and transitioning to the target state j=| [symbol] [symbol] .

FIG. 11A shows an electron-spin up fraction as a function of the nuclear spin configurations for a second example 2P quantum dot system before an initialisation protocol has been performed.

FIG. 11B shows an ESR measurement after the initialisation protocol has been performed on the second example 2P quantum dot system.

FIG. 12A shows the electron-spin up fraction as a function of the nuclear spin configurations for a second example 3P quantum dot system before an initialisation protocol has been performed.

FIG. 12B shows the ESR measurement after the initialisation protocol has been performed on the second example 3P quantum dot system.

FIG. 13A shows an electron-spin up fraction as a function of the nuclear spin configurations for an example 4P quantum dot system before an initialisation protocol has been performed.

FIG. 13B shows an ESR measurement after the initialisation protocol has been performed on the example 4P quantum dot system.

FIG. 14A shows the amplitude and direction of the AC electric field applied to an example 3P quantum dot.

FIG. 14B shows the Rabi frequencies for the electric field 33.6 kV/m.

### DETAILED DESCRIPTION

### Overview

The spin states of electrons or nuclei in a semiconductor material are good candidates to carry quantum information and act as quantum bits (or qubits) for a quantum computing system. To perform quantum computation three important steps are required—initialisation of qubits, control of qubits, and readout of individual qubits. Some aspects of the present disclosure provide new and improved techniques for qubit initialisation and control.

One type of quantum computing system is based on spin states of individual qubits where the qubits are electron and/or nuclear spins localised inside a semiconductor quantum chip. These electron and/or nuclear spins are confined either in gate-defined quantum dots or on donor atoms that are positioned in a semiconductor substrate. The weak magnetic coupling to the environment inherent to donor qubits in silicon results in high coherence times. Single- and two-qubit operations above the error correction threshold have been demonstrated using AC magnetic fields.

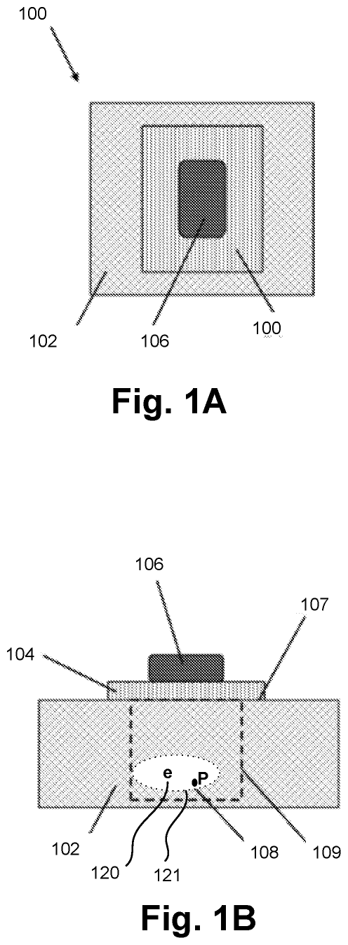

FIG. 1 illustrates an example spin qubit device 100 formed in a silicon substrate using a donor atom. FIG. 1A is a top view of the qubit device 100. FIG. 1B is a cross-sectional side view. The qubit device 100 may be used for a quantum computer comprising a plurality of these qubits. As shown in the figure, the qubit device 100 is formed in a structure comprising a semiconductor substrate 102 and a dielectric 104. In this example, the substrate is isotopically purified silicon (Silicon-28) and the dielectric is silicon dioxide. In other examples, the substrate may be silicon (Si). Where the substrate 102 and the dielectric 104 meet an interface 107 is formed. In this example, it is a Si/SiO2 interface. To form the qubit, a donor atom 108 is located within the substrate 102 inside region 109 under a gate 106. The donor atom such as a phosphorus atom 108 can be introduced into the substrate using nano-fabrication techniques, such as hydrogen lithography provided by scanning-tunnelling-microscopes, or industry-standard ion implantation techniques. In this example, qubit device 100 includes a single atom 108 embedded in the silicon-28 crystal. However, the methods described herein may be applied to qubit devices 100 including clusters of more than one embedded atom 108.

An electron 120 is loaded onto the device 100 by the gate electrode 106. The physical state of the electron 120 is described by a wave function 121—which is defined as the probability amplitude of finding an electron in a certain position. Donor qubits in silicon rely on using the potential well naturally formed by the donor atom nucleus to confine the electron spin.

The gate electrode 106 is located above region 109 and is operable to interact with the donor atom 108. For example, gate electrode 106 may be used to induce an AC electric field in the region between the interface 107 and the donor atom 108 to modulate a hyperfine interaction between the electron 120 and the nucleus of the donor atom 108, where the hyperfine interaction is the interaction between the electron spin and the nucleus spin of the donor atom.

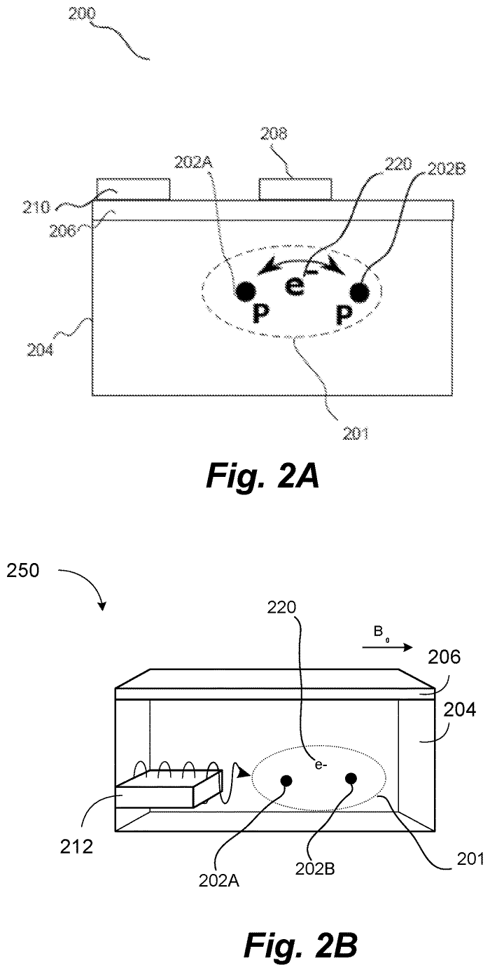

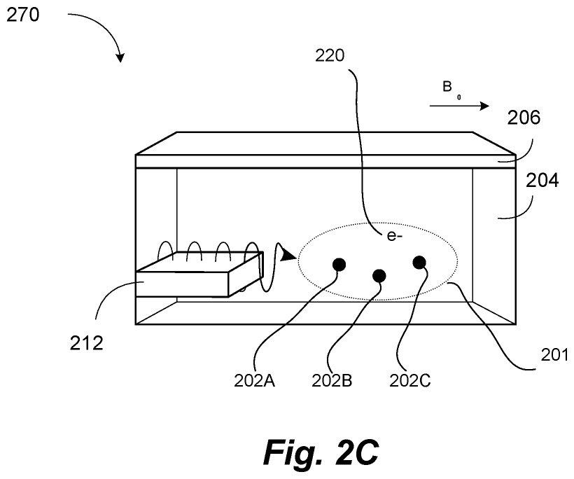

FIG. 2A shows a multi-donor quantum dot device 200. To form the qubit device 200, two donor atoms 202A and 202B are located within a quantum dot 201 in a semiconductor substrate 204. In some examples the donor atoms 202A, 202B are phosphorus atoms. In this example, qubit 200 includes two donor atoms 202, which herein are generally referred to as a 2P quantum dot. The silicon substrate 204 is topped by a barrier material/dielectric 206 such as silicon dioxide. Further, a gate 208 and an antenna 210 may be located on the dielectric 206 in a region above the multi-donor quantum dot 201. Voltages may be applied to gate 208 to confine an electron 220 in the quantum dot 201. Electron 220 may be shared by the two donor atoms 202A, 202B.

FIG. 2B shows another example of a multi-donor quantum dot device 250. This is similar to the device shown in FIG. 2A. The only difference being the placement of the gates. In FIG. 2A, the gates were displayed as being placed on top of the dielectric 206. In FIG. 2B, the gates are located within the semiconductor substrate 204. In some embodiments, the one or more gates 212 are placed within the same plane as the donor dots. The in-plane gates may be connected to the surface of the substrate via metal vias (not shown). In some examples, a multi-donor quantum dot device may include gates both on the surface (as in FIG. 2A) and within the semiconductor substrate (as in FIG. 2B).

Voltages may be applied to gate electrode 212 to confine one or more electrons 220 in the quantum dot 201. In the 2P quantum dot with one electron, there are three spins (the two nuclear spins from the donors and the spin of the electron). As such, each of the three spins may be considered a qubit.

FIG. 2C shows another example of a multi-donor quantum dot device 270. To form the qubit device 270, three donor atoms 202A, 202B, and 202C are located within a quantum dot 201 in a semiconductor substrate 204. In some examples, the donor atoms 202A, 202B, and 202C are phosphorus atoms. In this example, qubit 270 includes three donor atoms 202, which herein are generally referred to as a 3P quantum dot. Electron 220 may be shared by the three donor atoms 202A, 202B, and 202C.

In other examples, there may be m donor atoms—where m is an integer. In some examples there may be up to 10 donor atoms in the quantum dot device. In the case where there are m donor atoms that are phosphorus atoms, the multi-donor quantum dot may be called an mP quantum dot. In a general quantum dot system with m donors and one electron, there are m+1 total spins and therefore m+1 possible qubits.

The spin of electron 220 in the 2P quantum dot 201 is strongly coupled to the nuclear spins of the two donor atoms via the hyperfine interaction. Where the hyperfine interaction is the interaction between the electron spin and a nucleus spin of the donor atom. This hyperfine interaction is tens to hundreds of MHz, depending on the donor configuration in the quantum dot. As such, the frequency at which the electron qubit is operated changes for different nuclear spin configurations. For example, in a 2P quantum dot there are four nuclear spin configurations, namely: | [symbol] [symbol] , | [symbol] [symbol] , | [symbol] [symbol] [symbol] [symbol] , | [symbol] [symbol] . Where, the first arrow indicates the nuclear spin state of the first donor 20A and the second arrow indicates the nuclear spin state of the second donor 202B, or vice versa. This variability in qubit operation frequency in multi-donor quantum dots introduces a significant challenge for single-qubit operation of the electron spin.

A key component of a scalable quantum computer is that qubits can be individually addressed to apply quantum gates. However, qubit addressability has been a challenge for spin qubit devices since quantum gates typically require a mechanism for distinguishability in the frequency domain.

One particular part of qubit addressability is an initialisation protocol. Preparation of a qubit into a well-defined initial state is one of the key requirements to perform any quantum computation. Existing multi-qubit initialisation methods of donor quantum dot devices are inefficient and may be difficult to scale up.

One option to control the nuclear spins of the donor atoms is using nuclear magnetic resonance (NMR). In particular, NMR allows for control over the nuclear spins, if they are individually addressable. Therefore, NMR can be used for initialisation of the nuclear spins to any desired configuration. However, it introduces limitations and requires more hardware.

NMR operates at a very different frequency band than ESR (10-100 MHz rather than 20-40 GHz for ESR). As such, a transmission line (not shown) that delivers the signal is required for broadband operation. Thus, the requirement for broadband operation introduces performance limitations since different instruments are required for radio frequency ranges. Further disadvantages of using NMR include the limitations on the instrument delivering the radio frequency (RF) signal, which are normally solved by using two separate instruments—again introducing hardware overhead.

Another current technique is the use of post-selection. This is where the electron qubit is addressed using a single frequency corresponding to one of the nuclear spin configurations. The measurement is repeated multiple times and the measurement result is averaged. The data is then filtered and all the measurements conducted when the nuclear spins are not in the right configuration are discarded, with respect to the one nuclear spin configuration corresponding to the single qubit frequency being chosen. This circumvents the requirement to initialise the quantum system in a desired initial state. However, this post-selection method is highly inefficient. It introduces a time overhead by a factor of at least 2^{m}, where m is the number of donors in the system.

Frequency multiplexing is another method used. Rather than addressing the qubit at one frequency, this method addresses the qubit using the frequencies corresponding to each of the nuclear spin configurations. Therefore, regardless of the initial nuclear spin configuration, the electron qubit can be addressed. Again, this method is highly inefficient since effective qubit operation benefits from maximising the available RF driving power. However, the total RF power introduces heating effects and is therefore limited by the cooling power of the fridge used to hold the device. As such, with multiplexing, only a fraction of 2^{-m} of the total power is used to drive the qubit and the rest is dissipated and generates heat. A lower power at the qubit driving frequency slows the qubit operation speed of the qubit, namely, how quickly an operation can be performed. Ultimately, this will limit the quantum gate fidelity.

Aspects of the present disclosure propose and demonstrate an initialisation protocol for multi-donor spin qubits in semiconductors that can be used in quantum computation in current and future implementations of quantum processing/computing systems. The initialisation protocol according to aspects of the present disclosure can initialise the m+1 spins of a multi-donor dot system in a specific state as a prerequisite for any computation step. The initialisation protocol offers a number of advantages over known techniques. The nuclear configuration can be initialised with high fidelity to a specific configuration by a series of pulses within the ESR frequency band, allowing efficient operation of the electron qubit at a single frequency using maximum driving power, with zero hardware overhead and minimal time overhead.

According to some other aspects of the present disclosure, there is provided a mechanism for controlling the Rabi frequencies such that qubit initialization and control can be faster and more efficient than previously known techniques. In particular, aspects of the present disclosure control the Rabi frequencies by altering the angle of the electric field applied to the quantum device.

### Electron Spin Resonance (ESR) and EDSR in Multi-Donor Quantum Dot

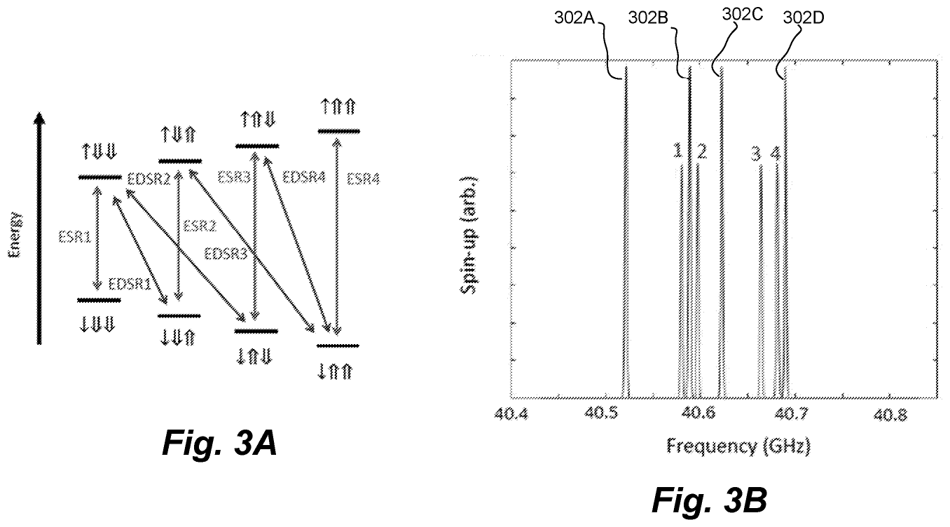

FIG. 3A shows an energy level diagram for an example 2P quantum dot.

For a 2P quantum dot there are 2²=4 possible nuclear spin configurations, namely: | [symbol] [symbol] , | [symbol] [symbol] [symbol] , | [symbol] [symbol] [symbol] , | [symbol] [symbol] . There are eight total spin states for a 2P quantum dot with one electron. They are: | [symbol] [symbol] , |↑ [symbol] [symbol] [symbol] [symbol] , |↑ [symbol] [symbol] [symbol] , | [symbol] [symbol] [symbol] >, [symbol] [symbol] |↓ [symbol] [symbol] , where the first single line arrow denotes the electron spin. For a general multi-donor quantum dot system with m donors and one shared electron there are a total 2×2^{m} total spin states. The eight total spin states are shown arranged by relative energy in FIG. 3A. The four total spin states corresponding to the down-spin electron are lower in energy than the four total spin states corresponding to the up-spin electron.

FIG. 3A also shows eight possible transitions between the spin states driven by electron spin resonance (ESR) or electron dipole spin resonance (EDSR). In particular, there are four possible EDSR transitions—labelled EDSR1—EDSR4 and there are four possible ESR transitions—labelled ESR1-ESR4.

ESR is a direct means to drive an electron between its two spin states. In the presence of an external magnetic field B₀ an electron's spin energy levels are no longer degenerate. The two spin states |↑>, |↓> are separated by an energy difference ΔE. Thus, by applying an AC magnetic field the electron spin can change from the spin-down state |↓> to the spin-up state |↑>, or vice-versa. ESR is due to the coupling of the electron's intrinsic magnetic moment to an external magnetic field B₀.

In particular, ESR is a transition between opposite electron spin states but the same nuclear spin configuration. For example in a 2P system the four ESR transitions are:

[symbol] ↑ [symbol] |H_{ESR1}|↓ [symbol] >, [symbol] [symbol] [symbol] [symbol] [symbol] ↑ [symbol] [symbol] [symbol] |H_{ESR2}|↓ [symbol] [symbol] >, [symbol] [symbol] [symbol] |H_{ESR3}|↓ [symbol] [symbol] >, |H_{ESR4}|↓ [symbol] [symbol] .

EDSR in donor systems on the other hand is due to the modulation of the hyperfine coupling of the electron spin and the nuclear spins of the donor atoms in the system. EDSR is mediated by an electric field that simultaneously flips the electron spin and one of the nuclear spins in the multi-donor system. For a 2P system, there are four possible EDSR transitions, as shown in FIG. 3A.

FIG. 3B shows the frequencies of the ESR and EDSR spin up transitions of FIG. 3A for a 2P quantum dot. For example, in order to excite the 2P quantum dot system from the spin state |↓ [symbol] [symbol] to the spin state | [symbol] [symbol] , a single frequency corresponding to the ESR frequency (ESR4) of approximately 40.7 GHz, as an example, may be applied to gate 208. This ESR frequency (ESR4) is shown as the vertical peak 302D in FIG. 3B. The ESR and EDSR frequencies are proportional to the applied magnetic field and can be changed over a large range.

The EDSR pulses may be generated with a single tone similar to ESR using the on-chip microwave antenna (gate 208) or using the gate electrodes (210 or 212). The EDSR transitions are electron-nuclear flip-flop transitions that can be performed via modulation of the hyperfine interaction between a nuclear spin and the electron spin. This modulation of the hyperfine interaction may be achieved by applying an electric field that shifts the electron wavefunction away from the donor nucleus.

In order to drive one of the EDSR transitions, the hyperfine interaction must be modulated at a frequency that corresponds to the energy between the two allowed states. For example, in FIG. 3A there are four EDSR transitions shown—each with a different corresponding driving frequency as shown by peaks 1, 2, 3, 4 in FIG. 3B. Also shown in FIG. 3B are the four ESR peaks, where each ESR transition corresponds to a different driving frequency shown by peaks 302A, 302B, 302C, and 302D.

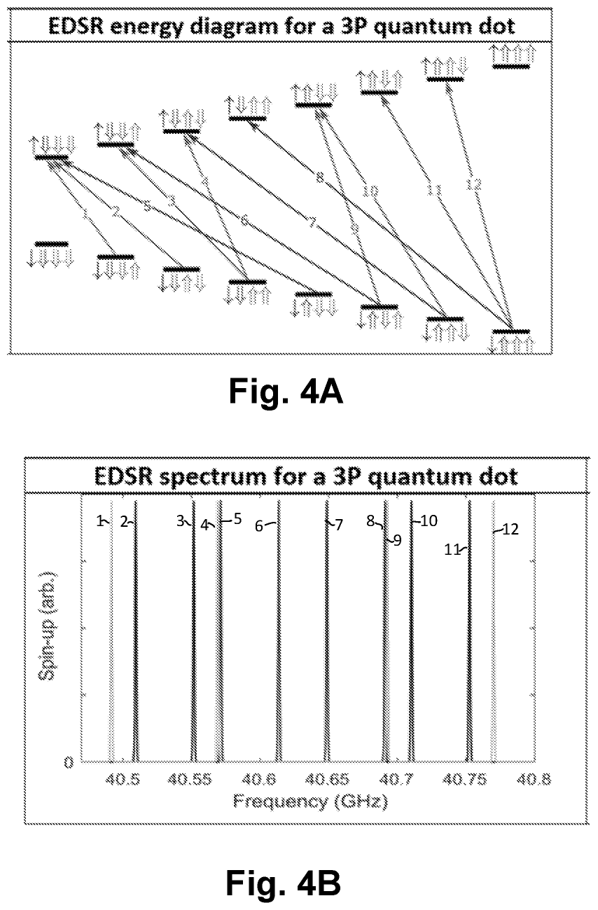

FIG. 4A shows the EDSR energy diagram for a 3P quantum dot. For a 3P quantum dot, there are a total of 2³=8 nuclear spin configurations and a total of 16 total spin-states. For the example 3P quantum dot, the hyperfine coupling for the first nuclear spin is 201 MHz, the hyperfine coupling for the second nuclear spin is 77 MHz and the hyperfine coupling for the third nuclear spin is 42 MHz. The eight nuclear spin states are shown by relative energy levels. The bottom row of states corresponds to the eight nuclear spin states with a spin-down electron and the top row corresponds to the eight nuclear spin states with a spin-up electron. There are 12 EDSR transitions (1-12) shown as connecting lines between the top and bottom states (EDSR transitions 5, 6, 7, and 8 flip the spin state of the first nuclear spin flips, EDSR transitions 2, 3, 10, and 11 flip the spin state of the second nuclear spin and EDSR transitions 1, 4, 9 and 12 flip the spin state of the third nuclear spin flips). There are also eight ESR transitions (not shown) in FIG. 4A. The ESR transitions only flip the electron spin and leave the nuclear spins unaffected. Therefore, the ESR transitions connect the bottom states with the top state directly above it, as per FIG. 3A.

Different NMR frequencies are required to individually address the three nuclear spins. The NMR frequency is related to hyperfine interaction by the following equation—

$$NMR frequency = \frac{hyperfine}{2} \pm nuclear Zeeman$$

where the nuclear Zeeman depends on the static magnetic field and the ± depends on the electron spin being up or down. The addressability frequencies of the individual nuclear spins depends on their environment. The frequency to address nuclear spins is in the MHz range, while the EDSR and ESR frequencies are in the GHz range. Thus, the requirement for broadband operation by a transmission line is not required here. FIG. 4B shows a plot of the EDSR spectrum for the 3P quantum dot (ESR spectrum not shown). The x-axis is the frequency in units of GHz and the y-axis shows the spin-up probability of the nuclear spins. The frequency of all 12 EDSR transitions to the electron spin-up state are shown. All the EDSR transitions (1-12) are in the order of tens of GHZ, more specifically in the 40-41 GHz range. The ESR transitions are also in the range of 40-41 GHz, but not shown. Accordingly, a narrow frequency range is required for operating both ESR and EDSR; hence, there are no specific performance requirements for a transmission line; and no requirements for additional frequency generator equipment.

This EDSR driving protocol may be applied to an mP quantum dot, or to any multi-donor quantum dot with up to 10 donor atoms.

### The Initialisation Protocol

Hyperfine-based EDSR may be used to drive electron-nuclear transitions in multi-donor qubits in silicon according to aspects of the present disclosure. The initialisation protocol disclosed herein is a deterministic and high-fidelity initialisation protocol of the nuclear spin configuration. Thereby it allows performing quantum gate operations on the donor electron qubit at a single frequency, and thus eliminating the need for NMR, frequency multiplexing or post-selection for the electron qubit operation. In summary, EDSR-based polarisation constitutes a powerful tool for operation of a multi-qubit system within a single quantum dot required for scaling of qubit count.

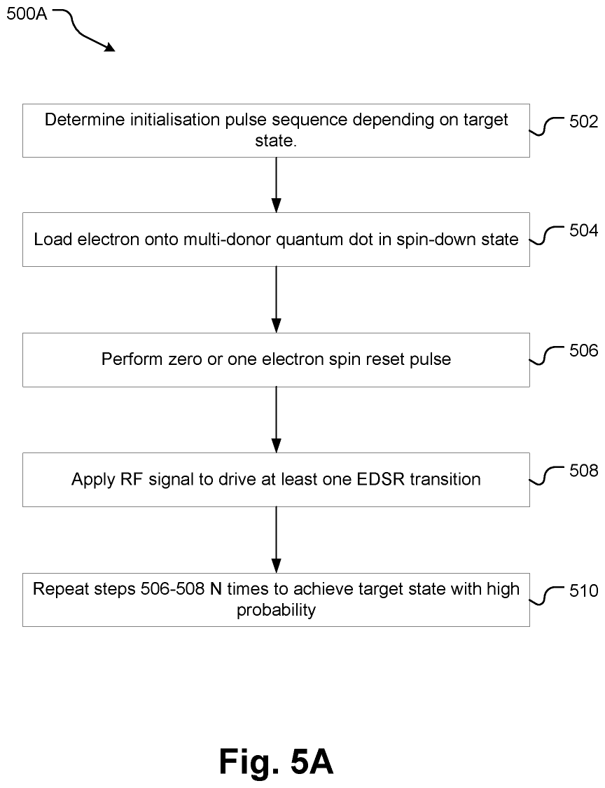

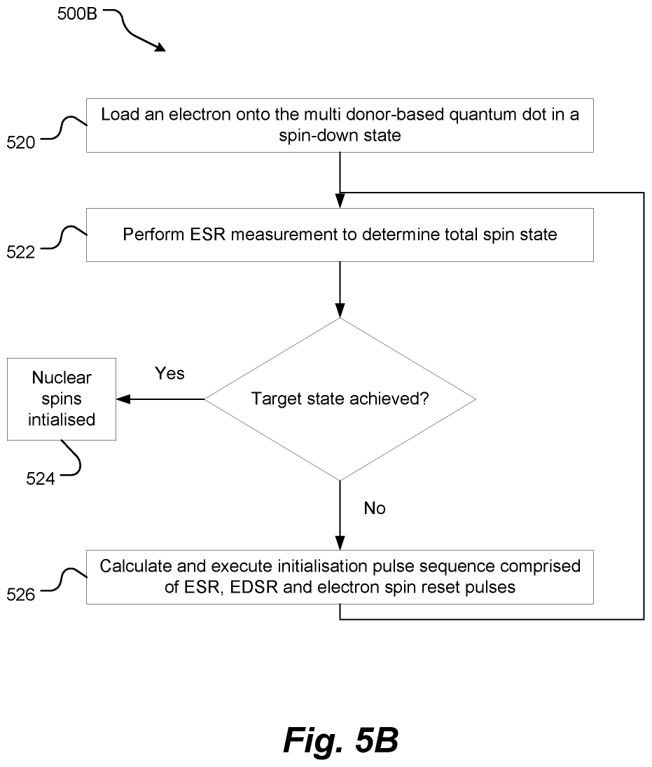

FIG. 5A is a flowchart illustrating an example initialisation protocol 500A according to aspects of the present disclosure. Initialisation protocol 500A consists of a series of EDSR pulses alternating with at least one ESR pulse to yield a target state. In one example, the target state may be the total spin-down state. The total spin-down state may then be used as the initial state for a quantum measurement or operation of the qubit. For example, in the 2P quantum dot system the initial target state may be the |↓ [symbol] [symbol] state. In other examples, the target state may be any spin state of the multi-donor quantum dot system.

The method 500A commences at step 502, where a initialisation pulse sequence is determined depending on the target state. This initialisation pulse sequence is independent of the initial state.

For an example 2P quantum dot system, the following are examples ofpulse sequences for achieving different pre-determined target states—see FIG. 3A.

TABLE A
Example pulse sequence for initialisation

| Target State | Example pulse sequence |
|---|---|
| \| ↓ [symbol] [symbol] | i) Electron reset pulse |
| | ii) EDSR4 |
| | iii) EDSR1 |
| | iv) Electron reset pulse |
| | v) EDSR2 |
| | vi) Electron reset pulse |
| \| ↓ [symbol] [symbol] [symbol] | i) Electron reset pulse |
| | ii) ESR_{ALL} |
| | iii) EDSR4 |
| | iv) EDSR1 |
| | v) Electron reset pulse |
| | vi) EDSR3 |
| | vii) Electron reset pulse |
| \| ↓ [symbol] [symbol] [symbol] | i) Electron reset pulse |
| | ii) EDSR4 |
| | iii) EDSR1 |
| | iv) Electron reset pulse |
| | v) ESR_{ALL} |
| | vi) EDSR2 |
| | vii) Electron reset pulse |
| \| ↓ [symbol] [symbol] | i) Electron reset pulse |
| | ii) ESR1, ESR2, ESR3, ESR4 |
| | iii) EDSR4 |
| | iv) EDSR1 |
| | v) Electron reset pulse |
| | vi) ESR_{ALL} |
| | vii) EDSR3 |
| | viii) Electron reset pulse |

Where ESR_{ALL} for the 2P quantum dot comprises the following ESR transitions: ESR1, ESR2, ESR3, and ESR4—see FIG. 3A. The ESR_{ALL} pulse may be performed in two ways. One method for performing ESR_{ALL} pulse is to apply all ESR1, ESR2, ESR3 and ESR4 pulses sequentially. Another method for performing ESR_{ALL} is to use frequency multiplexing (a standard RF technique) to apply the ESR pulses simultaneously—this method may save time. It will be appreciated that ESR_{ALL} for multi-donor quantum dot systems will comprise all the ESR transitions.

Next, at step 504, an electron is deterministically loaded onto the multi-donor quantum dot in the spin down state. In some examples, the electron is loaded onto the mP quantum dot by applying a voltage to a gate electrode. The voltage may be applied to at least one of the surface gate electrodes, 208, and 210 in FIG. 2A or via an in-plane gate electrode 212 in FIG. 2B or 2C.

In an example 2P system, the electron 220 is loaded deterministically in the spin-down state. As such, the system may be in one of the four total spin states: |↓ [symbol] [symbol] , |↓ [symbol] [symbol] [symbol] , |↓ [symbol] [symbol] [symbol] , |↓ [symbol] [symbol] —see FIG. 3A. For initialisation protocol 500A, it is not necessary to determine the initial state.

In some examples, multiple electrons may be loaded onto the multi-donor quantum dot system and the spin of the unpaired electron can be used as the electron spin qubit in the device.

Next, at step 506 zero or one electron spin reset pulses are performed. If zero electron reset pulses are required, nothing need be done and the method may proceed to step 508. An electron spin reset pulse may be performed using an ESR pulse or by unloading and loading an electron on the quantum dot or, alternatively, the electron spin reset pulse may be performed by applying voltages to gate electrodes. In order to drive an ESR transition using the electron spin reset pulse, an RF signal is applied to at least one of the gate electrodes or transmission line. The ESR transition flips the electron spin, while leaving the nuclear spin unchanged. For example, to transition from spin-state in |↑ [symbol] [symbol] > to spin-state |↓ [symbol] [symbol] > ESR2 can be used in FIG. 3A.

Next, at step 508 an RF signal is applied to the gate electrodes or to a transmission line in order to drive at least one EDSR transition. The applied signal corresponds to the EDSR transition that moves the total spin state closer to the target state. The EDSR transition is driven to perform a controlled SWAP gate on one of the nuclear spins from spin-up to spin-down or vice versa while simultaneously slipping the electron spin.

For example, if the initial state is the lowest energy spin-state |↓ [symbol] ), then the EDSR signal may correspond to the EDSR4 transition to yield state |↑ [symbol] [symbol] ). Here the EDSR4 transition drives a controlled SWAP gate on the second nuclear spin and the electron spin. In another example, if the initial state is the lowest energy spin-state |↓ [symbol] ), then the RF signal applied to the ate electrode or a transmission line may correspond to the EDSR3 transition that yields state |↑ [symbol] [symbol] ). Here, the EDSR3 transition drives a controlled SWAP gate on the first nuclear spin.

Next at step 510, steps 506 and 508 are repeated N times to achieve the target state with high probability. As such, the target state has been achieved due to the high fidelity of the process and the very high probability that the EDSR signal(s) has achieved the target state. Here, N is any integer greater than or equal to one. In principle, steps 506 and 508 may be repeated as many times as needed. The device can be engineered to have large EDSR efficiency and therefore high fidelity so that it should be possible to achieve initialisation with N=1.

Method 500A is a unconditional initialisation protocol since it works without requiring any feedback during the process—i.e., there is no need to measure the spin state during the initialisation protocol. As such, for any mP quantum dot system only a subset of the total number of transitions may lead to robust processes with a high probability of achieving the target state. For example, in the 2P quantum dot system at step 510, the total spin-down target state is achieved and the system has been initialised. The qubit device is now ready to perform a quantum operation. The probability of achieving the target state may be increased through device design and may be highly efficient (probability~1).

For example, if the target state is |↓ [symbol] [symbol] , then at step 502 the initialisation pulse sequence is determined to achieve this target state. From Table A, the initialisation sequence is the following:
i. Electron reset pulse
ii. EDSR4
iii. EDSR1
iv. Electron reset pulse
v. EDSR2
vi. Electron reset pulse

It will be appreciated that the pulse sequences corresponding to each target state are designed to arrive at that target state regardless of the initial state. For example, in the case of the initial state being |↑ [symbol] [symbol] , then using method 500A, at step 502 the initialisation pulse sequence is determined depending on the target state is |↓ [symbol] [symbol] . For example, see above pulse sequence i-vi.

Next at step 504, an electron is loaded onto the 2P quantum dot in a spin-down state. Next at step 506, zero electron reset is performed as the electron is in the spin-down state. Next, at step 508 an RF signal is applied to drive EDSR4 and EDSR1 transitions. In this case, the EDSR4 transition is applicable/effective. If the state was |↓ [symbol] [symbol] [symbol] then transition would be applicable. At the end of step 508, the spin state is | [symbol] [symbol] [symbol] . Next, at step 510, steps 506 and 508 are repeated N times to achieve target state with high probability. Thus, returning to step 504, an electron reset pulse is performed. The electron spin reset pulse is performed using an ESR transition, unloading and loading an electron or by voltages applied to gate electrodes. Now the spin state is | [symbol] [symbol] [symbol] . Next, at step 508, an RF signal is applied to drive EDSR2 transition—yielding the spin state |↑ [symbol] [symbol] . Returning again to step 506, an electron spin reset pulse is performed, yielding the final target state |↓ [symbol] [symbol] .

Similarly, the example initialisation pulse sequence can be used to robustly transform any initial spin state into the target state |↓ [symbol] [symbol] .

FIG. 5B is a flowchart illustrating an alternative deterministic series of method steps 500B for an example initialisation protocol according to aspects of the present disclosure.

The method 500B commences at step 520, where an electron is deterministically loaded onto the multi-donor quantum dot in the spin down state. In some examples, the electron is loaded onto the mP quantum dot by applying a voltage to a gate electrode. The voltage may be applied to at least one of the surface gate electrodes, 208, 210 in FIG. 2A or via an in-plane gate electrode 212 in FIG. 2B.

Next at step 522, an ESR measurement may be performed to determine if the system is in the target state. If the spin state is determined to be the target state then the nuclear spins of the multi-donor quantum dot system are initialised at step 524.

For example, in a 2P quantum dot, at step 522, an ESR measurement is performed and the result of the ESR measurement is that the total spin configuration is in the |↑ [symbol] [symbol] state. If this is the target state—then the nuclear spins are initialised and the method 500B terminates at step 524.

However, if at step 522 the determined total spin state is not the target state, then method 500B proceeds to step 526. At step 526, an initialisation pulse sequence is calculated that would transform the initial state to a target state. The initialisation pulse sequence is comprised of ESR transition(s)/electron spin reset pulses, and EDSR transition(s). The initialisation pulse sequence corresponds to the sequence of ESR and EDSR transitions, for example the transitions shown in FIGS. 3A and 4A, that transform the known initial state to the known target state.

Returning to the example of a 2P quantum dot system, if the total spin state is determined to be |↑ [symbol] [symbol] and this is not in the target state, then an initialisation pulse sequence comprising ESR, EDSR, and electron spin reset pulses is calculated and then executed at step 526.

For an example 2P quantum dot system, the target state may be the total spin-down state |↓ [symbol] [symbol] . Thus, a pulse sequence that transforms the initial state |↑ [symbol] [symbol] to |↓ [symbol] [symbol] is calculated.

One possible initialisation pulse sequence that transforms |↑ [symbol] [symbol] to |↓ [symbol] [symbol] is—see FIG. 3A:
i) Reset electron: |↑ [symbol] [symbol] to |↓ [symbol] [symbol]
ii) EDSR3: |↓ [symbol] [symbol] to |

[symbol]

[symbol]

[symbol]

[symbol]
iii) Reset electron: |↑ [symbol] [symbol] [symbol] to |

[symbol]

[symbol]
iv) EDSR1: | [symbol] [symbol] [symbol] to |↑ [symbol] [symbol]
v) Reset electron: |↑ [symbol] [symbol] to ↓

[symbol]

[symbol]

Once this initialisation pulse sequence is calculated, it is executed. An RF signal is applied to the gate electrodes (e.g., gates 208, 210, and/or 212) or to a transmission line in order to drive an EDSR transition. In this example, the applied signal corresponds to the EDSR transition that moves the total spin state closer to the total spin-down state. The EDSR transition is driven to perform a controlled SWAP gate on one of the nuclear spins.

The electron spin reset pulse may be executed by performing an ESR transition. Alternatively, the electron spin reset pulse may be executed by unloading and loading an electron on the quantum dot. Alternatively, the electron reset pulse may be executed by applying voltages to gate electrodes. In one example, step (i) may be performed using an ESR transition, step (iii) may be performed by unloading and loading an electron on the multi donor quantum dot, and step (v) may be performed by applying a voltage pulse to gate electrodes. In other example initialisation pulse sequences, the electron reset may be performed using different methods and combinations thereof.

Once the initialisation pulse sequence has been executed, method 500B again proceeds to step 522, where an ESR measurement is performed to determine the total spin state—and thus, if the target state has been achieved.

Returning to the example of a 2P quantum dot, at step 522 the ESR measurement is performed and it is determined that the total spin state is |↓ [symbol] [symbol] . Since in this example, this is the target spin state the method terminates at step 524 and the nuclear spins have been initialised.

After the completion of the initialisation protocol, the multi-donor quantum dot system is initialised and ready for use in qubit operation. Although the methods 500A and 500B have been explained as commencing with the initial state | [symbol] [symbol] , the protocol succeeds regardless of the initial spin-state.

In some examples, the initialisation protocol 500B can be performed multiple times to ensure that the state is initialised with high fidelity. As such, the initialisation protocol is robust to errors.

In another embodiment, the initialisation protocol may be used for a quantum processing system comprising a plurality of multi-donor quantum dots.

### Experimental Results

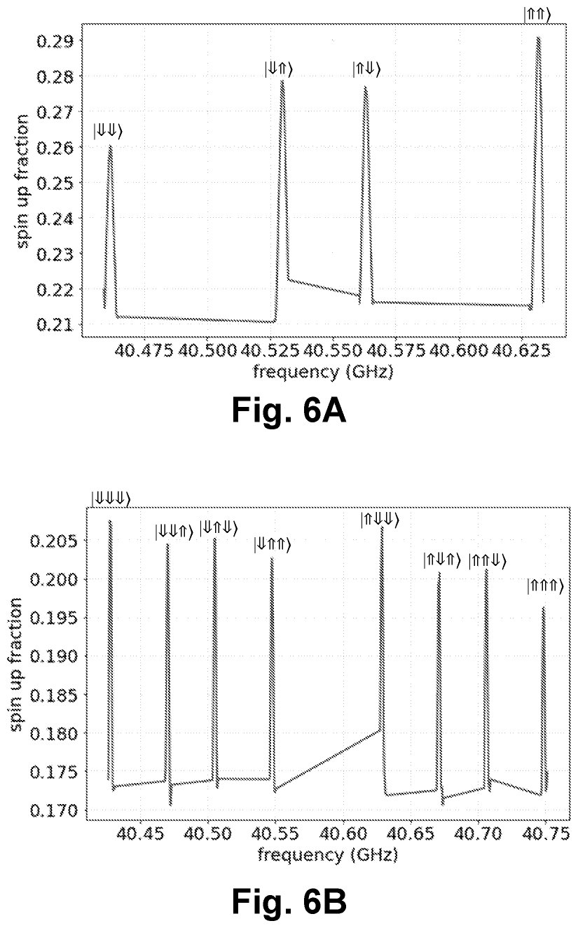

FIGS. 6A and 6B show experimental results for a first example 2P and 3P quantum dot system, respectively. The ESR peak amplitude, measured over time, is a direct measure of the efficiency of the initialisation protocol. Without applying the initialisation protocol, the system has a similar probability of being in any one of the nuclear spin configurations.

FIG. 6A shows the electron-spin up fraction as a function of the nuclear spin configurations for a first example 2P quantum dot system. The first example 2P quantum dot system has the following hyperfine interactions: A₁=65 MHz and A₂=103 MHz. There are four peaks at specific frequencies corresponding to the four nuclear spin configurations possible for the 2P quantum dot system. The height of each of the peaks corresponds to the probability that the system is in that nuclear spin configuration.

FIG. 6B shows the electron-spin up fraction as a function of the nuclear spin configurations for the first example 3P quantum dot system. The 3P quantum dot system has the following hyperfine interactions: A₁=42 MHz, A₂=77 MHz and A₃=201 MHz. There are eight peaks at specific frequencies corresponding to the eight nuclear spin configurations possible for the 3P quantum dot system. The height of each of the peaks corresponds to the probability the system is in that nuclear spin configuration

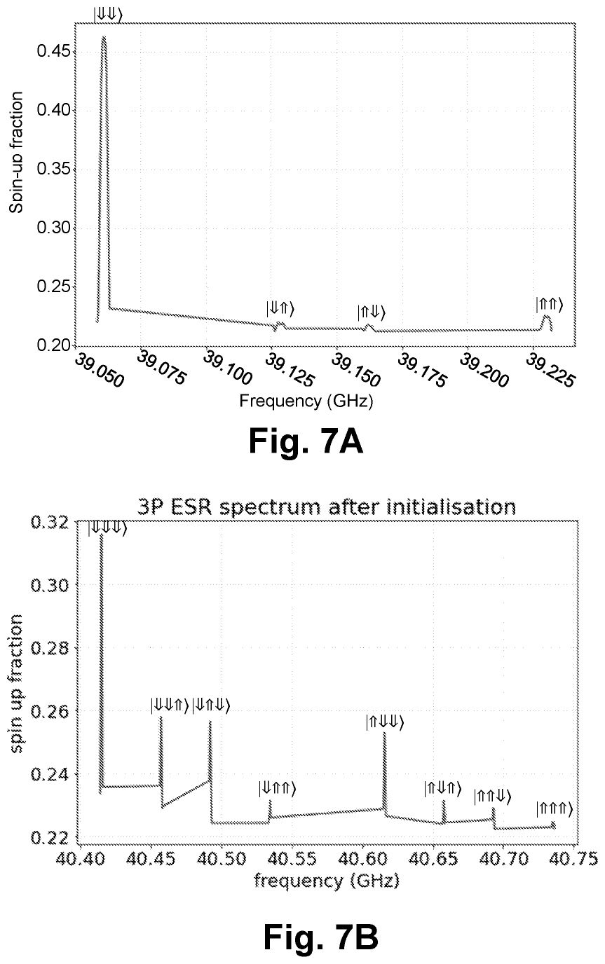

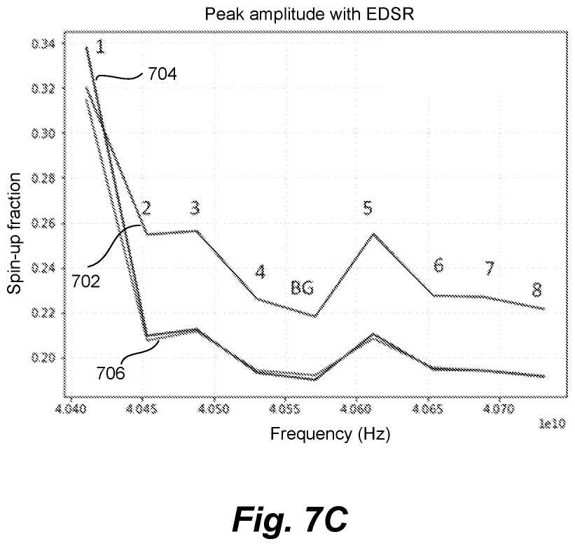

With a successful initialisation protocol, it is expected that a significant suppression of all ESR peaks except one will occur. This outcome, using an initialisation protocol like the one disclosed herein to initialise to the target state | [symbol] [symbol] for the example 2P quantum dot (| [symbol] [symbol] for the example 3P quantum dot), is shown in FIGS. 7A and 7B.

FIG. 7A shows the ESR measurement after the initialisation protocol 500A has been performed on the first example 2P quantum dot system, showing frequency in GHz against the measured electron spin-up fraction. As such, it can be seen that the 2P quantum dot system is in the nuclear spin-state | [symbol] [symbol] .

FIG. 7B shows the ESR measurement after the initialisation protocol 500A has been performed on the first example 3P quantum dot system, showing frequency in GHz against the measured electron spin-up fraction. It can be seen that the 3P quantum dot system is in the nuclear spin-state | [symbol] [symbol] .

FIG. 7C is a plot showing the peak amplitude with EDSR for the 3P quantum dot. In particular, the plot shows the spin-up fraction on the y-axis and the frequency of the EDSR pulse on the x-axis. BG in the figure refers to background measurement where a frequency away from any resonances is purposefully applied to see how the measurement changes in time and as a reference for the different peak heights.

Due to the large number of EDSR transitions (1-8) in the 3P case, there are potentially several different efficient initialisation protocols. Here, there are three different initialisation pulse sequences shown—702 (for large hyperfine spin), 704 (for medium hyperfine spin) and 706 (for small hyperfine spin), all leading to a similar outcome of efficient initialisation of the first | [symbol] [symbol] peak. The three pulse sequences correspond to the same pulse sequence used to initialize the qubit in the | [symbol] [symbol] state. This pulse sequence involves initializing different nuclear spins—e.g., pulse sequence 702 is for a qubit that is initially in a state that has a large hyperfine value, the pulse sequence 704 is for a qubit that is initially in a state that has a medium hyperfine value and the pulse sequence 706 is for a qubit that is initially in a state that has a small hyperfine value.

After the nuclear spin configuration is initialised using the initialisation protocol disclosed herein, the electron qubit is addressable at a single frequency. The initialisation protocol yields a stable electron qubit allowing coherent control of the qubit.

By applying an AC electric field to gate electrodes, the electron qubit can be driven between the |↓ [symbol] [symbol] total spin-state and the |↑ [symbol] [symbol] total spin-state—this yields Rabi oscillations constituting the oscillatory behaviour of a two-level system.

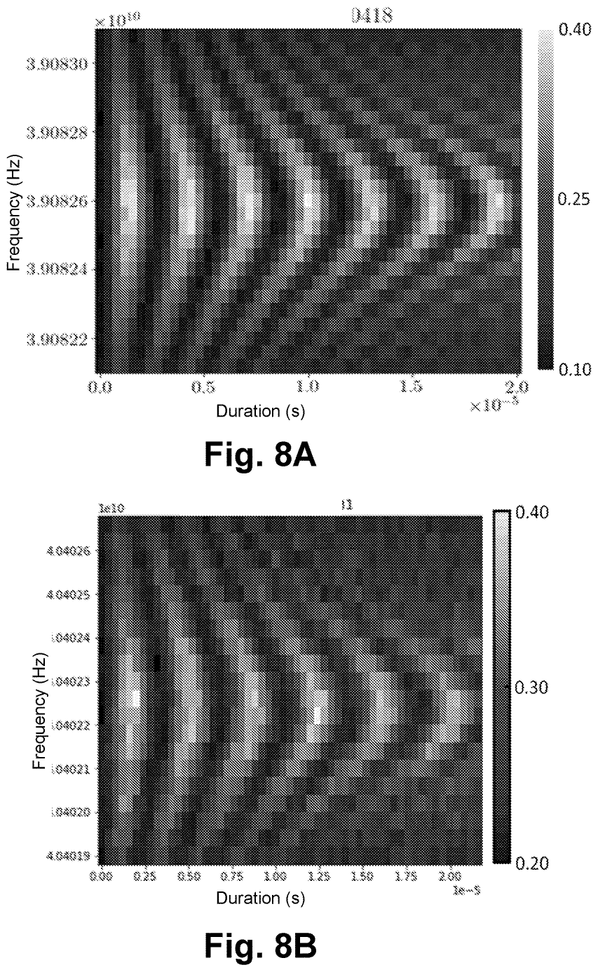

FIGS. 8A and 8B show the Rabi-chevron experimental results for the first example 2P and 3P quantum dot systems, respectively. On the x-axis is the duration and on the y-axis is the frequency. For the 2P quantum dot system coherent Rabi oscillations are observed at approximately 39.0826 GHz (as shown by the lighter color portion of the plot). For the 3P quantum dot system coherent Rabi oscillations are observed at approximately 40.40225 GHz.

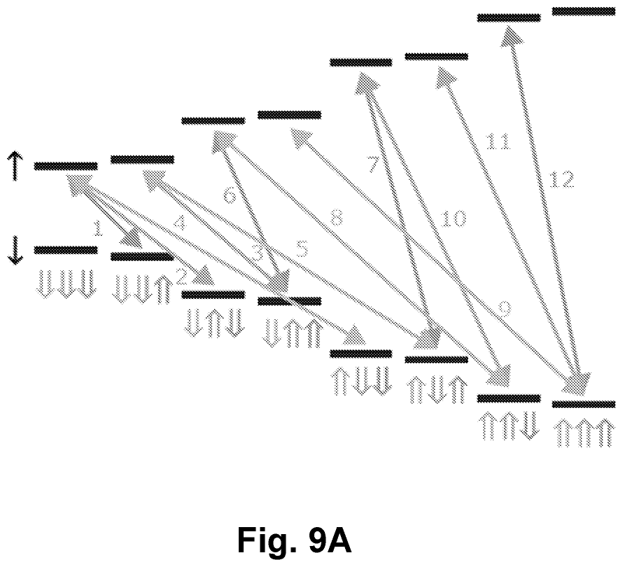

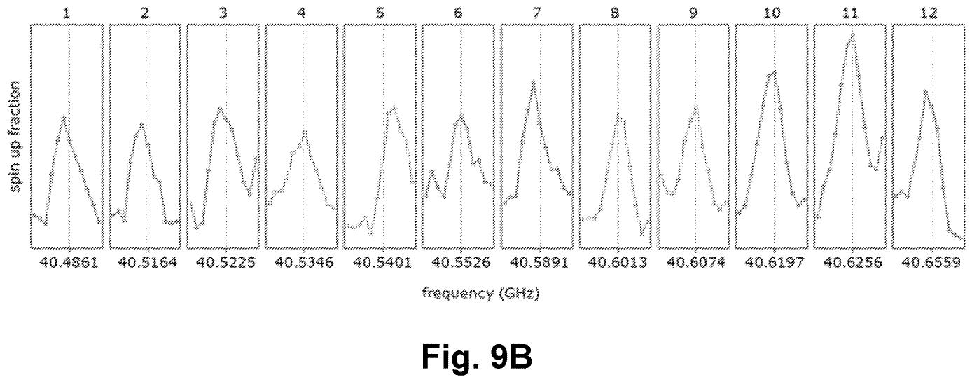

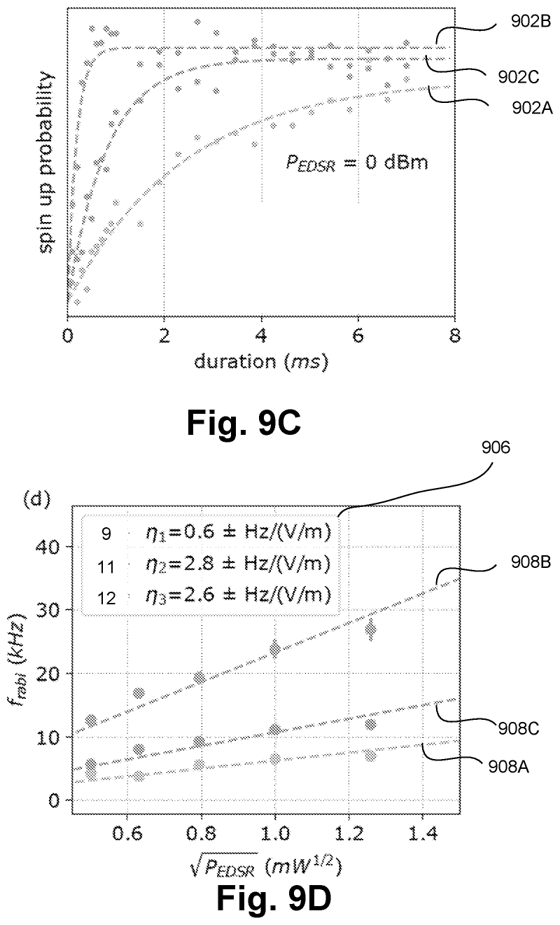

FIG. 9A shows the EDSR energy diagram for the first example 3P quantum dot system. As discussed above with reference to FIG. 4A, for a 3P quantum dot there are 12 EDSR transitions (1-12) shown as connecting lines between the top and bottom states. These EDSR transitions correspond to angular momentum conserving electron-nuclear flip-flop transitions. There are also eight vertical ESR transitions (not shown).

Different NMR frequencies are required to individually address the three nuclear spins I₁, I₂ and I₃, respectively. These frequencies were determined directly from the measured ESR spectra for the 3P quantum dots. As noted above, the addressability frequencies of the individual nuclear spins depends on their environment—hence these NMR frequencies differ from the NMR frequencies required for the 3P device of FIG. 4A. Four of these transitions (EDSR transitions 4, 5, 8, and 9) correspond to a flip of the first nuclear spin I₁ where the second and third nuclear spins remain unchanged e.g., [symbol] , [symbol] [symbol] , [symbol] [symbol] and [symbol] . Four of these transitions (EDSR transitions 2, 3, 10, and 11) correspond to a flip of the second nuclear spin I₂ where first and third nuclear spins remain unchanged. The remaining four transitions (EDSR transitions 1, 6, 7, and 12) correspond to a flip of the third nuclear spin I₃ where the where the first and second nuclear spins remain unchanged.

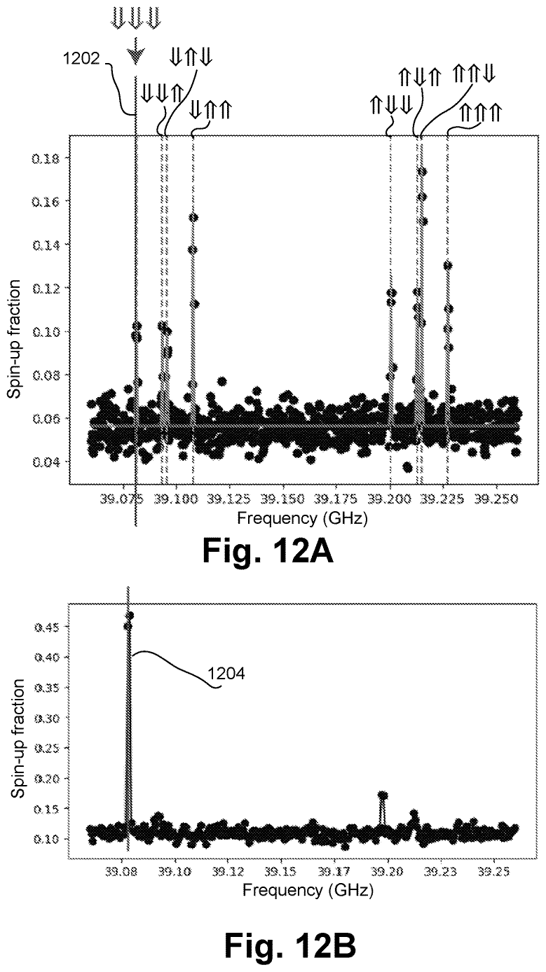

FIG. 9B shows a plot of the measured EDSR spectrum corresponding to the 12 different transition frequencies of the first example 3P quantum dot. The x-axis shows frequency in GHz and the y-axis shows the electron spin-up fraction. For each of the 12 EDSR transitions (1-12) a central frequency value is shown. Thus, FIG. 12B shows the frequency—in GHz—that drives each of the 12 EDSR transitions. Each of the 12 EDSR transitions are labelled on the top of plot.

In order to characterise a 3P quantum dot, the EDSR spectrum is measured. To ensure all the EDSR transitions are captured in this measurement, a pulse sequence that randomises the nuclear configuration is introduced. First, an electron is loaded onto the 3P quantum dot with a random spin state by quickly pulsing across 0 →1 charge transition line of the quantum dot. Next, an electron-nuclear SWAP gate is performed by applying the 4 EDSR transitions corresponding to the same nuclear spin. This drives the nuclear spin to a random initial state. For example, by applying EDSR transitions 4, 5, 8, and 9 that effect the first nuclear spin-state. This process is then repeated for the remaining nuclear spins. For example, performing an electron-nuclear SWAP gate by applying the 4 EDSR transitions that effect the second nuclear spin—namely, EDSR transitions 2, 3, 10, and 11. Similarly, EDSR transitions 1, 6, 7, 12 are applied to perform another electron-nuclear SWAP gate for the third nuclear spin. After performing this pulse sequence, the nuclear spin configuration is randomised and initialised.

Next, the electron is re-initialised to the spin-down state |↓ [symbol] using voltages applied to gates. Next, an adiabatic inversion EDSR pulse is applied, where the frequency of the pulse is adiabatically swept around the expected EDSR frequencies. This flips the electron to the |↑ [symbol] manifold conditional on the random initial nuclear spin configuration. The measured EDSR spectrum shown in FIG. 12B matches calculated EDSR values determined using the hyperfine couplings obtained from ESR measurements.

The EDSR initialisation protocol relies on controlled SWAP gates between the electron and the nuclear spins and is implemented using adiabatic inversion pulses. Consequently, the achieved initialisation fidelity depends strongly on the efficiency of the adiabatic inversion pulses, i.e., the efficiency of flipping the electron spin conditional on the initial nuclear spin configuration. To characterise the inversion efficiency Landau-Zener interferometry is performed on three of the EDSR transitions (one transition for each nuclear spin). In this experiment, EDSR transitions 9, 11 and 12 are used. First, the system is initialised into the |↑ [symbol] [symbol] state. Next, an adiabatic inversion pulse at the target EDSR transitions is applied. In particular, the frequency is swept linearly around the transition frequency (chirp)—e.g., see frequencies shown in FIG. 12B for transitions 9, 11 and 12. The inversion rate is given by the Landau-Zener formula:

$$P = 1 - exp ( - 4 {π}^{2} \frac{{f}_{r}^{2} τ}{ω} ) \qquad ( 1 )$$

Moreover, the inversion rate strongly depends on the rate of the frequency sweep ω/τ (τ is the inversion pulse duration, ω is the frequency width of the sweep) compared to the driving strength fᵣ (here expressed in terms of the corresponding Rabi frequency).

FIG. 9C shows the inversion probability for EDSR transitions 9, 11 and 12, corresponding to a flip of the first, second and third nuclear spin, respectively—when starting from initial state |↓ [symbol] [symbol] . The x-axis shows the pulse duration (τ) in milliseconds (ms) and the y-axis shows the electron spin-up probability. The electron spin-up probability was measured at a microwave output power 0 dBm. The dashed lines 902A, 902B and 902C are the fits to equation 1 for each of the three EDSR transitions, 9, 11, and 12 respectively. From the fitted data, the corresponding Rabi frequencies f_{r,i} can be obtained. The Rabi frequency for EDSR transition 9 is 6.47 kHz, for EDSR transition 11 is 23.78 kHz and for EDSR transition 12 is 11.12 kHz.

FIG. 9D is a plot showing the dependence of the Rabi frequency on the square-root microwave power for each of the three EDSR transitions, 9, 11 and 12. On the x-axis is the square-root power in units of mW. On the y-axis is the Rabi frequency in kHz. For each EDSR transition, the Rabi frequency is linearly dependent on the square-root power of the microwave output. The gradients of each line 908A (corresponding to transition 9), 908B (corresponding to transition 11) and 908C (corresponding to transition 12) is different for each nuclear spin. This linear dependence is expected.

Based on a realistic assumption that the micro-wave induced electric field (E) is equal at all three transition frequencies and donor locations, the different gradients represent different dipolar moments of the individual donors, coupling them to the electric drive with different strengths. To first order the coupling strength is given by the amplitude of the Stark shift created by the electric field, i.e., δAᵢ=ηᵢE. The stark shift is the splitting of energy levels due to an external electric field. Where, ηᵢ are the Stark coefficients, which are a measure of how the electric field E is split for each of the hyperfine couplings.

The Stark coefficients for each donor nuclear spin may be determined using atomistic tight-binding modelling. The Stark coefficients for each donor nuclear spin are shown in inset 906. These coefficients, combined with the measured Rabi frequencies f_{r,i}, constrain the direction and amplitude of the AC electric field at the qubit location. As such, both the direction and amplitude of the AC electric field may be obtained. In this example, the amplitude of the AC electric field is |E|=33.6±0.5 kV/m (at 0 dBm). This is in agreement with electric fields simulated using finite-element modelling of the antenna—e.g., gate 208 in FIG. 2A. In some examples, the AC electric field may be applied via an in-plane gate—e.g., gate 212 in FIG. 2B or 2C.

With a future re-design of the device architecture the microwave pulse can be applied to in-plane gate electrodes, inducing a stronger and more local field, and allowing faster and even coherent operation.

Finally, from the Landau-Zener calibration curve (FIG. 9C), an optimal pulse duration may be determined while managing the trade-off between device heating and pulse duration contributing to the overhead of the initialization protocol.

In one example, it was observed that when the microwave power exceeds 0 dBm more frequent device instabilities were also observed. Further, the pulse and pulse duration contributes to the overhead of the initialisation protocol. At 0 dBm, the inversion rate of I₂ and I₃ approaches unity for τ>4 ms, but is only ~70% for I₁. As such, in this example τ=5 ms was chosen for the actual initialisation sequence, to avoid making the sequence duration prohibitively long.

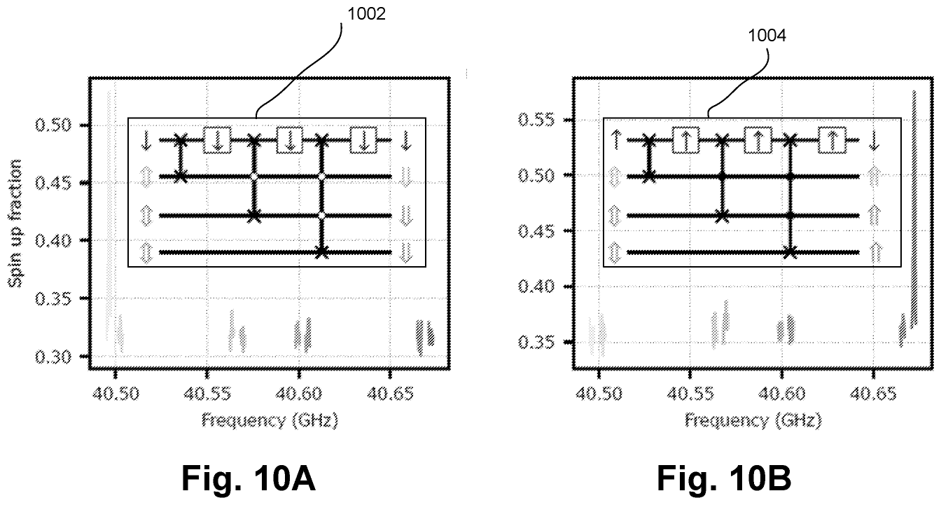

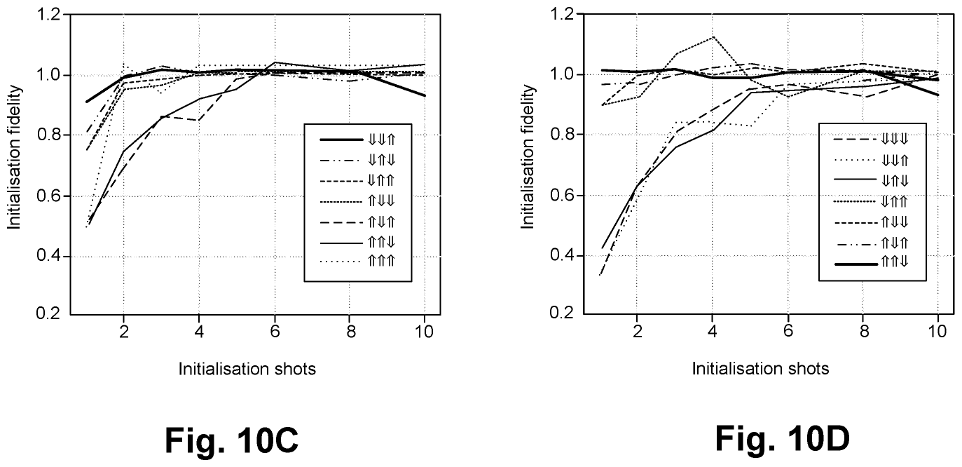

FIGS. 10A and 10B show the initialisation sequences for the nuclear spin states |↓ [symbol] [symbol] and |↓ [symbol] [symbol] , respectively. FIGS. 10A and 10B also show the measured ESR spectrum after applying the initialisation sequence.

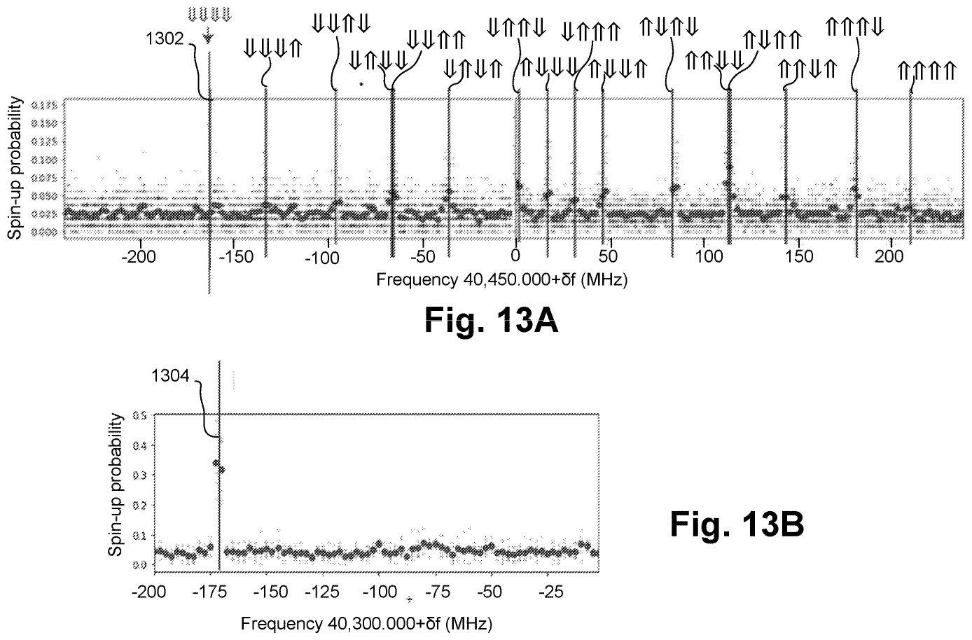

To initialise to nuclear spin configuration | [symbol] [symbol] starting from a random nuclear configuration, the electron spin is initialised to the spin-down state |↓ [symbol] and 4 EDSR pulses are applied. In this example, the EDSR pulses corresponding to EDSR transitions 4, 5, 8 and 9 are applied. This sequence transfers the spin down polarisation from the electron to nuclear spin I₁, unconditional of the states of the other two nuclear spins. The electron spin initialisation is repeated—i.e., flipping the electron from |↑ [symbol] to |↓ [symbol] . Then the EDSR pulses corresponding to EDSR transitions 2 and 3 are applied to initialise spin I₂ (conditional on spin I₁ already being | [symbol] [symbol] ). To conclude the nuclear initialisation sequence, the electron is initialised again and EDSR pulse corresponding to EDSR transition 1 is applied to initialise spin I₃ (conditional on spin I₁ and I₂ already being | [symbol] [symbol] ). This sequence of pulses is shown in inset 1002 of FIG. 13A. After completion of this initialisation process using EDSR, the ESR spectrum may be measured. FIG. 13A shows the measured ESR spectrum. The x-axis shows frequency in GHz and the y-axis shows the electron spin-up fraction. The measured ESR spectrum has a dominant peak at the lower end of the frequency region shown. This peak corresponds to the ESR transition when the nuclear spins are in the | [symbol] [symbol] . Therefore, the ESR spectrum confirm that the nuclear spins have been successfully initialised into the predetermined | [symbol] [symbol] .

The initialisation process for initialising the nuclear spins in the spin-up state | [symbol] [symbol] [symbol] is similar, although now the electron is initialised in the spin-up state |↑ [symbol] before each EDSR step. The pulse sequence is shown in inset 1004 of FIG. 10B. In some examples, the electron may be initialised in the spin-up state |↑ [symbol] by applying simultaneous ESR inversion pulse on all 8 ESR frequencies.

FIG. 10B shows the measured ESR spectrum after the initialisation process has been performed. The x-axis shows frequency in GHz and the y-axis shows the electron spin-up fraction. The measured ESR spectrum has a dominant peak at the higher end of the frequency region shown. This peak corresponds to the ESR transition when the nuclear spins are in the | [symbol] [symbol] state. Therefore, the ESR spectrum confirm that the nuclear spins have been successfully initialised into the predetermined | [symbol] [symbol] .

To further investigate and quantify the initialisation fidelity a series of repeated randomisation initialisation sequences interleaved with nuclear state readout to determine the nuclear configuration before and after initialisation are performed. Where, interleaving means that an initialisation sequence is performed, followed by readout—this may be repeated multiple times. First, the nuclear spin configuration of the 3P quantum dots is randomised. Next, a first nuclear readout sequence is performed by inverting and reading-out the electron spin at each one of the 8 ESR frequencies and averaging 60 times. This is followed by l initialisation attempts and then a second nuclear readout sequence. Knowing the nuclear configuration before and after initialisation allows for a Markov chain model to be used in order to construct a normalised transition probability matrix M. The initialisation fidelity from initial state i to the final state j is then given by the matrix element M_{j,i}.

FIG. 10C shows the initialisation fidelity starting from an initial state (i) and transitioning to the target state j= [symbol] [symbol] . On the x-axis is the number of initialisation attempts l ranging from 0 to 10. The y-axis shown the initialisation fidelity. In particular, the initialisation fidelity is shown starting from each one of the 7 possible initial states to the target state j=| [symbol] [symbol] , excluding the case when i=j, i.e., when the initial state is already at the target state) as a function of the number of initialisation attempts l. Similarly, FIG. 10D shows the initialisation fidelity is shown starting from each one of the 7 possible initial states to the target state | [symbol] [symbol] (excluding the case when=j, i.e., when the initial state is already at the target state) as a function of the number of initialisation attempts l.

These curves are normalised by the probability of starting and remaining in the target state (i=j case), which removes state readout and electron initialisation errors of about 5%. The 7 different initial configurations can be divided to two categories defined by the state of nuclear spin ii. From FIG. 12C one observes that I₁ has the lowest inversion rate as η₁ is smaller.

Consequently, from both FIGS. 10C and 10D the fidelity for I₁ to flip is lower for l<5. Averaging over the different initial nuclear spin configurations (black dashed line), an overall effective initialisation fidelity may be determined. For both | [symbol] [symbol] and | [symbol] [symbol] the overall effective initialisation fidelity was determined to be F̅=99±1% for l>5 [symbol] repetitions and F̅=70±3% per initialisation shot. The single shot fidelity can be further improved to be >99% by optimising the inversion efficiencies of the EDSR and performing higher fidelity electron spin initialisation.

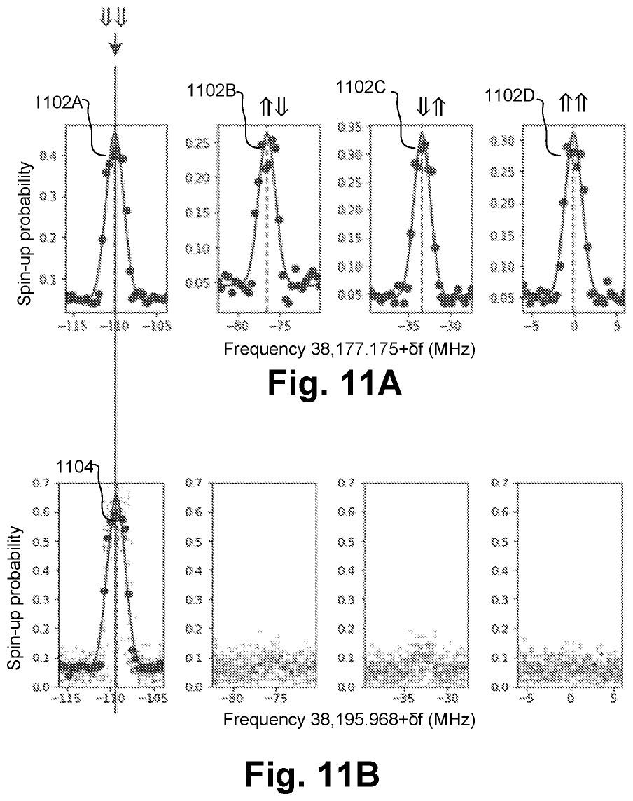

FIG. 11A shows the electron-spin up probability as a function of the nuclear spin configurations for a second example 2P quantum dot system, which has the following hyperfine interactions: A₁=33 MHz and A₂=77 MHz. The dots represent the experimental data whereas the solid lines represent the fit. The x-axis depicts the δf in MHz and the y axis represents the spin up probability. There are four spin-up probability peaks 902A-902D at specific frequencies corresponding to the four nuclear spin configurations for the second example 2P quantum dot system. In particular, the peaks 1102A, 1102B, 1102C and 1102D show the probability of the nuclear spins being in the | [symbol] [symbol] , | [symbol] [symbol] [symbol] , | [symbol] [symbol] [symbol] , and | [symbol] [symbol] states, respectively. The height of each of the peaks 1102A-D correspond's to the probability that the system is in that nuclear spin configuration, and as can be seen from FIG. 11A, the heights of all four probabilities is about the same.

Before the initialisation protocol is applied, there is substantially equal probability of the nuclear spins existing in any one of the four nuclear spin states.

FIG. 11B shows the ESR measurement after the initialisation protocol according to method 500A has been performed on the second example 2P quantum dot system. In particular, FIG. 11B shows the spin-up probability at different frequencies. It can be seen the probability of the nuclear spins being in the | [symbol] [symbol] state has has a peak 1104, whereas the [symbol] probability of the nuclear spins being in any other state is almost zero. As such, it can be seen that the second 2P quantum dot system has been initialised to the nuclear spin-state | [symbol] [symbol] .

FIG. 12A shows the electron-spin up fraction as a function of the nuclear spin configurations for a second example 3P quantum dot system, which has the following hyperfine interactions: A₁=12 MHz, A₂=15 MHz and A₃=119 MHz. There are eight peaks at specific frequencies corresponding to the eight nuclear spin configurations for the second example 3P quantum dot system. The height of each of the peaks corresponds to the probability the system is in that nuclear spin configuration. Before the initialisation protocol is applied, there is substantially equal probability of the nuclear spins existing in any one of the eight nuclear spin states. Peak 1202 show the probability of the nuclear spins being in the | [symbol] [symbol] state.

FIG. 12B shows the ESR measurement after the initialisation protocol according to method 500A has been performed on the second 3P quantum dot system, showing frequency in GHz against the measured electron spin-up fraction. As such, it can be seen that the second 3P quantum dot system has been initialised to the nuclear spin-state | [symbol] [symbol] —see peak 1204.

FIG. 13A shows the electron-spin up fraction as a function of the nuclear spin configurations for a 4P quantum dot system. The 4P quantum dot system has the following hyperfine interactions: A₁=30 MHz, A₂=68 MHz, A₃=97 MHz and A₄=180 MHz. There are 16 peaks at specific frequencies corresponding to the sixteen nuclear spin configurations for the 4P quantum dot system. The height of each of the peaks corresponds to the probability the system is in that nuclear spin configuration. Before the initialisation protocol is applied, there is substantially equal probability of the nuclear spins existing in any one of the sixteen nuclear spin states. Peak 1302 show the probability of the nuclear spins being in the | [symbol] [symbol] state.

FIG. 13B shows the ESR measurement after the initialisation protocol according to method 500A has been performed on the 4P quantum dot system, showing frequency in GHz against the measured electron spin-up fraction. As such, it can be seen that the 4P quantum dot system has been initialised to the nuclear spin-state | [symbol] [symbol] —see peak 1304.

### Electrical Control of Electron and Nuclear Spins

Electrical control of spins is desirable for qubit operation. Oscillating electric fields may be applied to a multi-donor quantum dot system locally or globally. For example, an AC electric field may be applied via one or more surface gate electrodes—e.g., gate 210 and/or gate 208 in FIG. 2A. In other embodiments, an AC electric field may be applied via an in-plane gate—e.g., gate 212 in FIG. 2B. Electrical control of nuclear spins can deterministically polarize the nuclear spins. This electrical control of nuclear spins may then be used for a multitude of purposes. For example, performing two qubit gate operations, creation of local magnetic field etc.

Inventors of the present have discovered that by changing the direction of the oscillating electric field, the driving strength of the EDSR can be varied. This is because changes in the direction of the electric field affect the coupling between the electron spins and electric field—thereby changing the strength of the EDSR signal required to initialize or control the corresponding mP qubit. Further, the inventors have found that at a particular direction of the electric field, the drive strength of the EDSR can be optimized for an mP qubit.

From the derivation of the Rabi frequencies of the EDSR drive, an estimation of the AC electric field radiated from the antenna at the dot location can be found. The hyperfine coupled donor-electron system, e.g., 3P system with an electron, has a static spin Hamiltonian of the form—

$${H}_{0} = {ω}_{n} {I}_{z} + {ω}_{e} {S}_{z} + AI \cdot S \qquad ( 2 )$$

where, ωₙ (ωₑ) is the donor nuclear (electron) Larmor frequency, I(S) is the nuclear (electron) spin operator and A is the hyperfine constant. The EDSR causes nuclear-electron spin flip-flop transition and the relevant I_{z}+S_{z}=0 subspace has the Hamiltonian;

$${H}_{0} = ( \begin{matrix}\frac{- {ω}_{e}}{2} + \frac{{ω}_{n}}{2} - \frac{A}{4} & \frac{A}{2} \\ \frac{A}{2} & \frac{{ω}_{e}}{2} - \frac{{ω}_{n}}{2} - \frac{A}{4}\end{matrix} ) \qquad ( 3 )$$

When an AC electric field is applied, it couples to the spin levels through the Stark effect. For systems with more than one donor atom, the lack of spherical symmetry gives rise to finite dipole moments and therefore, they have linear Stark shift. For a small AC electric field, the linear Stark shift will be the dominant term, therefore the AC electrical drive (in the I_{z}+S_{z}=0 subspace can be expressed as:

$${H}^{′} = Δ A ( t ) I \cdot S = η ϵ cos ( ω t ) ( \begin{matrix}- \frac{1}{4} & \frac{1}{2} \\ \frac{1}{2} & - \frac{1}{4}\end{matrix} ) \qquad ( 4 )$$

Here, η is the linear Stark coefficient and c is the amplitude of the AC electric field. Transferring to the eigenbasis of H₀ making a Rotating Wave Approximation and choosing an appropriate energy origin, the full Hamiltonian of the system may be expressed as:

$$H = {H}_{0} + {H}^{′} = ( \begin{matrix}\frac{1}{2} ( {ω}_{0} - ω ) & \frac{ηϵ}{4} \\ \frac{ηϵ}{4} & - \frac{1}{2} ( {ω}_{0} - ω )\end{matrix} ) \qquad ( 5 )$$

where, ωₒ is the eigen-splitting of H₀ and the approximation

$$ηϵ \frac{{ω}_{n} - {ω}_{e}}{4 \sqrt{{A}^{2} + {( {ω}_{n} - {ω}_{e} )}^{2}}} \approx ηϵ .$$

Hence the Rabi frequency of the drive is

$$\frac{ηϵ}{2}$$

at the resonant frequency.

Due to the close proximity of the donors, the AC electric field is the same at all the donor locations. It means that the Stark coefficients are proportional to the Rabi frequencies with the proportionality constant being the amplitude of the AC electric field.

For a small electric field c the hyperfine constant Aᵢ(E) of donor i can be written up to first order as:

$${A}_{i} ( ϵ ) = {A}_{i} ( 0 ) + ϵ {∇}_{ϵ} {A}_{i} {\vert}_{ϵ = 0} ⇒ Δ {A}_{i} ( ϵ ) = ϵ \cdot {∇}_{ϵ} {A}_{i} {\vert}_{ϵ = 0} \qquad ( 6 )$$

Here, ΔAᵢ(ϵ) is the hyperfine Stark shift of donor i and define ∇_{ϵ}Aᵢ|_{ϵ=0}=ηᵢ as the Stark coefficient vector for donor i. Therefore, the electric field response to the electron density at a donor site depends on the direction of the field. If the field is along \hat{n}, the Stark coefficient is ηᵢ·\hat{n}.

Accordingly, changing the angle of an applied AC electric field may optimise the Rabi frequencies for individual nuclear spin configurations. By doing so, the speed and efficiency of the initialisation protocol may be improved.

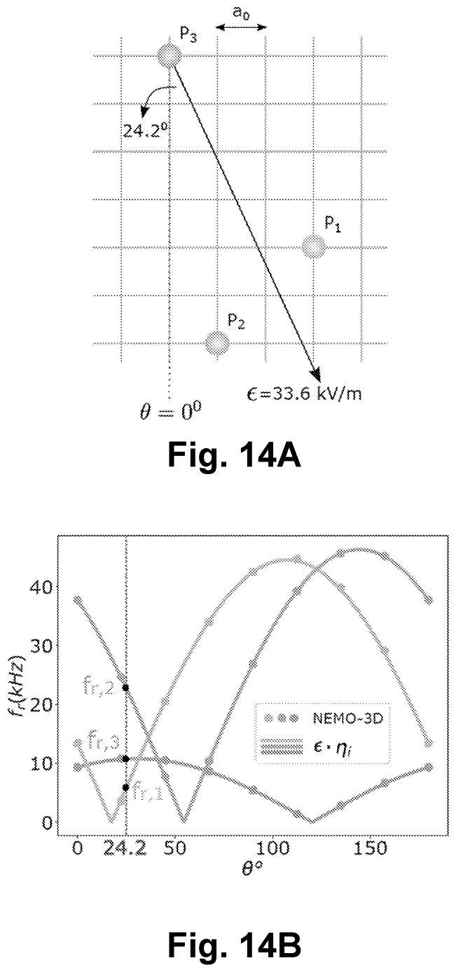

Using an atomistic tight-binding modelling tool, the best matching donor configuration was determined under an electric field with varying its direction. FIG. 14A shows the amplitude and direction of the AC electric field applied to an example 3P quantum dot.

Since the dot has a planar configuration, the dipole is only significant along the xy plane and hence the x and y components of the electric field are considered. The linearity assumption of the Stark shift is valid for as high as 100 kV/m of electric field. These simulations show that for the electric field applied at an angle of 24.20° with the vertical in FIG. 14A gives the Stark coefficients proportional to the Rabi frequencies observed in experiment. From this, the AC electric field amplitude was determined to be 33.6 kV/m at 0 dBm.

FIG. 14B shows the Rabi frequencies for the electric field 33.6 kV/m. At the previously mentioned angle of 24.2, the calculated Rabi frequencies are in good agreement with the experiment as shown in Table B.

TABLE B
Comparison of Rabi frequencies between experiment
and NEMO-3D simulations at 0 dBm.

| | f_{r, 1} (kHz) | f_{r, 2} (kHz) | f_{r, 3} (kHz) |
|---|---|---|---|
| Experiment | 6.47 | 23.78 | 11.12 |
| Simulation | 5.92 | 23.81 | 11.3 |

Further, although the quantum processing systems described herein have been shown with gate electrodes and a transmission line for controlling corresponding qubits, these may not always be necessary. In other embodiments and examples other control means may be utilized without departing from the scope of the present disclosure.

The present embodiments are, therefore, to be considered in all respects as illustrative and not restrictive.

As used herein, except where the context requires otherwise, the term “comprise” and variations of the term, such as “comprising”, “comprises” and “comprised”, are not intended to exclude further additives, components, integers or steps.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

1. A method for initialising a predetermined target spin state of a multi-donor quantum dot in a semiconductor substrate, the method comprising:
i) loading an electron onto the multi-donor quantum dot in a spin-down state;
ii) performing zero or one electron reset pulses;
iii) applying an RF signal to drive at least one EDSR transition; and
iv) repeating steps ii)-iii) N times to achieve the predetermined target spin state.

2. The method of claim 1, further comprising determining a initialisation pulse sequence dependent on the predetermined target spin state before performing step (i), and applying the pulse sequence.

3. A method for initialising a predetermined target spin state of a multi-donor quantum dot in a semiconductor substrate, the method comprising:
i) determining an initialisation pulse sequence dependent on the predetermined target spin state, the initialisation pulse sequence comprising at least one electron reset pulse and at least one EDSR transition;
ii) loading an electron onto the multi-donor quantum dot in a spin-down state;
iii) applying the initialisation pulse sequence;
iv) repeating step iii) N times to achieve the predetermined target spin state.

4. The method of any one of claim 2 or claim 3, wherein the initialisation pulse sequence is configured to achieve the target spin state independently of the initial spin state.

5. The method of claim 4, wherein each target spin state has an associated initialisation pulse sequence.

6. The method of any one of claims 2 to 5, wherein the initialisation pulse sequence is determined based on the initial and target spin states.

7. The method of any one of claim 1 to 6, further comprising the steps of:
performing an ESR measurement to determine a total spin state of the multi-donor quantum dot;
in accordance with a determination the total spin state of the multi-donor quantum dot is not in the target spin state, repeating steps (ii)-(iii) until the target spin state is achieved.

8. A method for initialising a predetermined target spin state of a multi-donor quantum dot in a semiconductor substrate, the method comprising:
i) loading an electron onto the multi-donor quantum dot in a spin-down state;
ii) performing an ESR measurement to determine the total nuclear spin state;
in accordance with a determination that the total nuclear spin state of the multi-donor quantum dot is not the target spin state:
iii) determining and executing an initialisation pulse sequence; wherein, the initialisation pulse sequence comprises at least one ESR spin reset pulse and at least one EDSR transition;
iv) performing an ESR measurement to determine the total nuclear spin state;
in accordance with a determination the total nuclear spin state of the multi-donor quantum dot is the target spin state, terminating the method;
in accordance with a determination that the total nuclear spin state of the multi-donor quantum dot is not the target spin state returning to step iii).

9. The method of any one of claims 1 to 8, wherein the target spin state is a total nuclear spin-down state.

10. The method of any one claims 1-9, wherein the RF signal to drive the at least one EDSR transition is applied to a transmission line.

11. The method of any one of claims 1-9, wherein the RF signal to drive the at least one EDSR transition is applied to at least one gate electrode in a plurality of gate electrodes.

12. The method of any one of the claims 1 to 11, where the multi-donor quantum dot is comprised of at least two phosphorus atoms.

13. The method of any one of claims 1 to 12, wherein the donor-based quantum dot is a 2P quantum dot.

14. The method of any one of claims 1 to 12, wherein the multi-donor quantum dot is a 3P quantum dot.

15. The method of any one of claims 1 to 12, wherein the multi-donor quantum dot has 4-10 phosphorus donor atoms.

16. The method of claim 5, wherein the multi-donor quantum dot is a 2P quantum dot, and the predetermined target spin state is the spin state |↓ [symbol] [symbol] , the initialisation pulse sequence comprises:
i) Electron reset pulse
ii) EDSR4
iii) EDSR1
iv) Electron reset pulse
v) EDSR2
vi) Electron reset pulse.

17. The method of claim 5, wherein the multi-donor quantum dot is a 2P quantum dot, and the predetermined target spin state is the spin state |↓ [symbol] [symbol] [symbol] , the initialisation pulse sequence comprises:
i) Electron reset pulse
ii) ESR1, ESR2, ESR3, ESR4
iii) EDSR4
iv) EDSR1
v) Electron reset pulse
vi) EDSR3
vii) Electron reset pulse.

18. The method of claim 5, wherein the multi-donor quantum dot is a 2P quantum dot, and the predetermined target spin state is the spin state |↓ [symbol] [symbol] [symbol] , the initialisation pulse sequence comprises:
i) Electron reset pulse
ii) EDSR4
iii) EDSR1
iv) Electron reset pulse
v) ESR1, ESR2, ESR3, ESR4
vi) EDSR2
viii) Electron reset pulse.

19. The method of claim 3, wherein the multi-donor quantum dot is a 2P quantum dot, and the predetermined target spin state is the spin state |↓ [symbol] [symbol] , the initialisation pulse sequence comprises:
i) Electron reset pulse
ii) ESR1, ESR2, ESR3, ESR4
iii) EDSR4
iv) EDSR1
v) Electron reset pulse
vi) ESR1, ESR2, ESR3, ESR4
vii) EDSR3
viii) Electron reset pulse

20. A quantum processing element configured to initialise a predetermined target spin state in a multi-donor quantum dot, the quantum processing element comprising:
a semiconductor substrate and a dielectric material forming an interface with the semiconductor substrate;
a multi-donor quantum dot embedded in the semiconductor substrate, the multi-donor quantum dot comprising at least two donor atoms, the at least two donor atoms sharing at least one electron; and
a control element for controlling the multi-donor quantum dot;
wherein the electron is loaded onto the multi-donor quantum dot in a spin-down state; and
wherein the control element is configured to:
apply an RF signal to drive at least one EDSR transition; and
apply at least one electron spin reset pulse;
thereby to achieve the target spin state and initialise the quantum dot.

21. The quantum processing element of claim 20, wherein the control element comprises at least one gate electrode.

22. The quantum processing element of claim 20, wherein the control element comprises a transmission line for applying the RF signal to drive at least one EDSR transition.

23. The quantum processing element of any of claims 20 to 22, wherein the donor atoms of the multi-donor quantum dot are phosphorus atoms, and the semiconductor substrate is a silicon substrate.

24. The quantum processing element of any one of claims 20 to 23 wherein the at least one gate electrode is fabricated within the semiconductor substrate.

25. The quantum processing element of any one of claims 20 to 23, wherein the at least one gate electrode is patterned on the semiconductor surface.

26. A quantum processing element configured to initialise a predetermined target spin state in a multi-donor quantum dot, the quantum processing element comprising:
a semiconductor substrate and a dielectric material forming an interface with the semiconductor substrate;
a multi-donor quantum dot embedded in the semiconductor substrate, the multi-donor quantum dot comprising at least two donor atoms, the at least two donor atoms sharing at least one electron; and
a control element for controlling the multi-donor quantum dot;
wherein the electron is loaded onto the multi-donor quantum dot in a spin-down state; and
wherein the control element is configured to perform the method of any one of claims 1-19.
